(19) United States
(12) Patent Application Publication
(10) Pub. No.: US 2026/0298531 A1
(43) Pub. Date: Oct. 1, 2026

(54) METHOD FOR LIQUEFYING CARBON DIOXIDE

(71) Applicant: CRYOCOLLECT, Paris (FR)

(72) Inventors: Haytham SAYAH, Paris (FR); Christelle BOU MALHAM, Paris (FR); Philippe Maria KHAIRALLAH, Paris (FR)

(21) Appl. No.: 19/477,020

(22) PCT Filed: Mar. 29, 2024
(86) PCT No.: PCT/EP2024/058740

§ 371 Date: Oct. 20, 2025

(30) Foreign Application Priority Data
Apr. 21, 2023 (EP) 23169225.2

(51) Int. Cl. F25J 3/02

(52) U.S. Cl. CPC F25J 3/0266; F25J 3/0204; F25J 2200/74; F25J 2205/40; F25J 2205/80; F25J 2215/04; F25J 2220/02; F25J 2230/30; F25J 2245/02; F25J 2270/12; F25J 2270/902

(57) ABSTRACT

The present disclosure relates to a method for producing liquid carbon dioxide from a gas comprising more than 70% by volume of carbon dioxide, and comprises the following consecutive steps: one or more filtration steps then one or more steps of cooling the gas, then a step of overpressurising the gas, one or more steps of cooling the gas, then a step of compressing the gas, then one or more filtrations then a step of drying the gas, then one or more filtrations then a step of liquefying the gas, and then a step of distilling the fluid so as to isolate the liquefied carbon dioxide.

### TECHNICAL FIELD

The present invention relates to a method for producing liquid carbon dioxide from a gas including more than 70% by volume of carbon dioxide. The invention also relates to a device for producing liquid carbon dioxide and its use.

### PRIOR ART

Currently, methods are being sought to valorize waste, particularly waste from biomass. To this end, methanization processes are being developed.

Methanization is a process of decomposing organic matter. It consists of fermenting livestock effluents or by-products from the agri-food industry, with the principle as follows: organic effluents are stored in an airtight tank called a “digester,” where they are subjected to the action of microorganisms (bacteria) in the absence of oxygen (anaerobic fermentation) for a determined residence time (generally about 60 days). This process generates biogas, which includes methane (CH₄, in proportions of 50% to 70%), and carbon dioxide (CO₂) as well as an organic residue (called “digestate” used as fertilizer). The biogas can be transformed into either electricity, gas, or vehicle fuel.

Methanization represents a substantial economic interest; the biogas produced can replace natural gas in all its current uses: heat production, electricity production, and vehicle fuel, and the digestate is fully valorized, notably as fertilizer whose composition is much more complete than that of a chemical fertilizer.

Methanization also presents an environmental interest, as biogas is a renewable energy source. Although its production and use still generate polluting emissions into the atmosphere (CO₂), these are less significant than those from fossil energies.

The method according to the invention aims to valorize a gas, a by-product of methanization. During methanization, a gas including mainly carbon dioxide, called “poor gas,” is produced. The invention aims to valorize this poor gas by isolating and purifying the carbon dioxide to obtain food-grade, or even pharmaceutical-grade, liquid carbon dioxide. The carbon dioxide produced can be used, for example, to produce sparkling water. It can be used in breweries. In the pharmaceutical field, it can be used for cryogenics. In agriculture, it can be used to heat greenhouses.

In the same context, it is also possible to valorize gases rich in carbon dioxide, which are produced by cement plants, or steam reforming or oxycombustion processes. In general, the method according to the invention aims to valorize gases rich in carbon dioxide, which are reaction by-products and are generally released into the atmosphere. The method according to the invention isolates the carbon dioxide present in these gases; the carbon dioxide is purified and then liquefied.

This method according to the invention aims to obtain carbon dioxide of very high purity. The liquefied carbon dioxide obtained can be food grade, complying with the EIGA Doc 126-11 standard (Annex 1, page 6) or pharmaceutical grade complying with the European Pharmacopoeia and GMP.

This method has the advantage of being energy-efficient and leading to good yield.

This method can also have the advantage of recycling all other components of the gas.

### SUMMARY

Thus, the invention relates to a method for producing liquid carbon dioxide from a gas including more than 70% by volume of carbon dioxide comprising the following successive steps:
a) one or more filtration steps using activated carbon then
b) one or more steps of cooling the gas, the temperature of the gas at the end of this step being between 1° and 20° C., then
c) a gas overpressure step, the pressure of the gas at the end of this step being between 1.05 and 1.40 bar,
d) one or more steps of cooling the gas, then
e) a gas compression step, the pressure of the gas at the end of this step being between 15 and 25 bars, then
f) one or more filtrations then
g) a gas drying step, then h) one or more filtrations then
h) a gas liquefaction step, the fluid at the end of this step being at a temperature between −25° C. and −35° C., then
i) a step of distilling the fluid to isolate the liquefied carbon dioxide
j) a step of recovering the carbon dioxide in liquid form from step j),
k) a step of liquefying the gas recovered at the top of the distillation column in step j), the gas at the end of this step being at a temperature between −35° C. and −45° C., then
l) a step of separating the liquid phase from the gas phase of the fluid resulting from the liquefaction step 1), then
m) a step of recycling the liquid phase resulting from the separation in step m) to the distillation step j).

The method may further include a particle filtration step between steps a) and b).

The method may further include a gas cooling step between steps h) and i).

The method may further include the following successive steps:
a step of heating the gas phase obtained from step m),
a step of membrane filtration of the heated gas phase,
a step of recycling the gas obtained from the previous filtration step and composed of more than 50% by volume relative to the total volume of carbon dioxide gas, before the overpressure step c).

The gas including more than 70% by volume of carbon dioxide may be a gas originating from a methanization unit, a gas originating from a biogas purification unit, a gas originating from a steam reforming unit, a gas originating from an oxycombustion unit, or a gas originating from a unit for recovering gases produced by a cement plant.

The invention also relates to a device for producing liquid carbon dioxide (1) from a gas including more than 70% by volume of carbon dioxide including the following elements, fluidically connected to one another and in this order:
at least two filtration units (F101, F102, F103) mounted in series,
a heat exchanger (E101) to cool the gas,
a booster (SP),
a buffer tank (TK101),
at least two exchangers (E102, E103) mounted in series,
an oil-free dry compressor (CP),
at least one filtration unit (F104, F105),
a drying device (D), to eliminate traces of humidity,
at least one filtration unit (F106),
a buffer tank (TK102),
at least one heat exchanger (E104),
a liquefier (E105),
a distillation column (DC),
the foot of the distillation column (DC) being fluidically connected to a pipe (C2) allowing the recovery of liquefied carbon dioxide,
the head of the distillation column (DC) being connected to a liquefier (E106) to liquefy the carbon dioxide remaining in the gas, then connected to a separator (Sep),
a pipe (C3) connects the separator (Sep) to the distillation column (DC), allowing the recycling of the liquid phase mainly including carbon dioxide.

The compressor (CP) may be a multi-stage compressor, equipped with at least two compressors mounted in series (CP201, CP202), and equipped with at least two heat exchangers (E211, E212 and E213, E214) mounted in series and positioned downstream of each compressor.

The liquefiers (E105, E106) may be connected to cooling devices, including at least two cooling circuits mounted in cascade (33, 34).

The separator (Sep) may be fluidically connected to a heat exchanger (E107), then to a membrane filtration unit (F107);
a pipe (C4) connects the filtration unit (F107) to the pipe upstream of the booster (SP) to recycle the gas including carbon dioxide.

The pipe (C2) arranged at the outlet of the distillation column (DC) may be connected to a valve (V), then to a storage tank (STK), recovering the liquefied carbon dioxide.

The device may include at least one filtration unit between the heat exchanger (E104) and the liquefier (E105).

The device may include at least one filtration unit between the buffer tank (TK102) and heat exchanger (E104).

The device may be arranged inside a container, preferably a maritime transport container.

The invention finally relates to the use of the device to liquefy a gas originating from a methanization unit, a biogas purification unit, a steam reforming unit, an oxycombustion unit, or a unit for recovering gases produced by a cement plant.

### BRIEF DESCRIPTION OF THE FIGURES

Non-limiting examples will now be discussed with reference to the figures.

FIG. 1 is a diagram of the installation implementing the method according to the invention. FIG. 1 also serves as a support for examples of the generalized invention.

FIG. 2 is a diagram of a two-stage compressor.

FIG. 3 is a diagram of a cooling device that can be used at the level of the liquefiers of the installation according to the invention.

### DETAILED DESCRIPTION

Other features, aspects, objects, and advantages of the present invention will become even clearer upon reading the following description.

It is specified that the expressions “from . . . to . . . ” and “between . . . and . . . ” used in the present description should be understood as including each of the mentioned limits.

Unless otherwise indicated, all temperatures given below are in degrees Celsius and all pressures are in bar and are absolute pressures. The notation “bar” in the present disclosure is therefore equivalent to the notation “bar a” or “bara” (designating absolute pressure).

In the sense of the present invention “heat exchanger” means a device allowing the transfer of thermal energy from one fluid to another fluid, without mixing them. The thermal flux crosses the exchange surface that separates the fluids.

### Method

The raw material of the method is a gas including mainly carbon dioxide. In the sense of the present invention “mainly” means a gas comprising more than 70% by volume of carbon dioxide relative to the total volume of the gas, preferably more than 80% by volume.

The method according to the invention can also be implemented on very pure carbon dioxide gases.

The other components of the gas can be methane, oxygen, nitrogen, hydrogen, carbon monoxide, hydrogen sulfide, water vapor, and volatile organic compounds hereafter referred to as VOC. The composition of the gas depends on the source process, i.e., the prior process. A gas from a cement plant does not have the same chemical composition as a gas from the purification of biogas generated by a methanizer.

At the inlet of the method, the temperature of the gas is preferably between 15° C. and 90° C., preferably between 20° C. and 40° C.

At the inlet of the method, the pressure of the gas is preferably at a pressure close to atmospheric pressure, advantageously between 1 bar and 1.1 bar.

The method according to the invention comprises the 14 consecutive steps as follows: steps a) to n).

Step a)—Filtration(s) Using Activated Carbon

At the beginning of the method, the gas undergoes one or more filtrations using activated carbon. Preferably, the method includes between one and five filtration steps using activated carbon, and more particularly between two and three filtration steps using activated carbon.

The filtration step using activated carbon aims to eliminate the volatile organic compounds present in the gas.

### Optional Filtration(s)

The gas thus filtered can then undergo one or more filtration steps, for example, a particle filtration to eliminate the particles of activated carbon potentially present in the gas, notably the residues of activated carbon in powder form, and the dust following the previous filtration steps on activated carbon.

The particle filter can, for example, be a molecular sieve.

Step b)—Cooling(s) of the Gas

The filtered gas undergoes one or more cooling steps using a heat exchanger. The thermal or calorific energy is extracted from the gas using a cooling source. This cooling source can be selected from air via an air-cooling device, water, or glycol water.

The purpose of this step is to impose a temperature on the gas at the beginning of the method. Indeed, the temperature of the gas at the inlet of the method is variable. It fluctuates notably depending on the type of process that generates the gas.

The one or more cooling steps thus allow a temperature between 1° and 20° C., preferably between 1° and 15° C., advantageously 12° C., to be reached.

According to one embodiment of the method according to the invention, the method includes two cooling steps, the first using air as the cooling fluid and the second using water as the cooling fluid.

The use of different cooling fluids and in this order allows a progressive decrease in the temperature of the gas and reduces the energy consumed if only one exchanger had been used.

According to another embodiment of the method according to the invention, the method includes two cooling steps, the first using air as the cooling fluid and the second using water as the cooling fluid and a particle filtration step preferably with a sieve to eliminate dust between these two cooling steps.

Step c)—Overpressure of the Gas

The gas then undergoes an overpressure step. The purpose of this step is to impose a pressure higher than atmospheric pressure at the inlet of the compressor used in step e). The booster sucks in the gas and compresses it to reach a pressure at the compressor outlet between 1.05 and 1.40 bar.

The gas then passes through a buffer tank, which functions to stabilize the pressure of the gas within the method. In other words, the buffer tank aims to cushion the flow fluctuations of the gas, which depend on the production process of this gas. This tank is positioned downstream of the booster and upstream of the compressor so that the pressure at the compressor inlet is constant.

Step d)—Cooling of the Gas

The gas then passes through one or more exchangers to be cooled before entering the compressor.

Suppression step c) slightly heats the gas. Moreover, compression step e) causes a significant rise in the temperature of the gas. Therefore, it is advantageous to cool the gas before its entry into the compressor so that the compression step is as efficient as possible.

This or these cooling step(s) allow a temperature between 5 and 40° C. to be reached before the compressor inlet.

Preferably, the method includes two cooling steps, the first using water as the cooling fluid and the second using glycol water as the cooling fluid.

The use of different cooling fluids and in this order allows a progressive decrease in the temperature of the gas and reduces the energy consumed if only one exchanger had been used.

Step e)—Compression of the Gas

At the compressor inlet, the pressure of the gas is between 1.05 and 1.40 bar. At the compressor outlet, the pressure of the gas is between 15 and 25 bars.

The increase in the pressure of the gas allows the power necessary for the liquefaction of carbon dioxide to be reduced and improves the yield of the method.

During this compression step, the gas must be compressed to at least a pressure higher than the triple point pressure of carbon dioxide, i.e., 5.18 bars, to avoid frosting.

Preferably, the compression is done in at least two steps, using a multi-stage compressor. At each stage, at the compressor outlet, at least two heat exchangers mounted in series are used to recover at different temperature levels the energy generated by the compression of the gas. Moreover, cooling the gas protects the compressor from possible overheating.

Preferably, an oil-free dry compressor is used. It avoids contamination of the gas with oil residues.

Preferably, the method uses a two-stage compressor. At the first compressor outlet, the temperature of the gas is between 110° C. and 210° C., preferably between 150° C. and 190° C. At the second compressor outlet, the temperature of the gas is between 150° C. and 220° C. The at least two exchangers mounted in series allow this temperature range to be reduced to between 25 and 50° C.

At the compressor outlet, the gas is preferably at 206° C. and 25 bars.

Step f)—Filtration(s)

At the compressor outlet, the gas is saturated with humidity.

The compressed gas undergoes one or more filtrations to eliminate condensates, dust, and possibly impurities generated during compression.

Filtration can be done on molecular sieves.

Step g)—Drying

The gas is then dried to eliminate remaining water traces and reach a dew point temperature at the drying device outlet between −65 and −45° C. at 25 bars or a water content below 20 ppm.

Preferably, a zeolite selectively adsorbing water is used. The device used for this drying step can be equipped with two columns, one adsorbing moisture traces from the gas and the second allowing water desorption, i.e., the regeneration of the column. A cyclic and continuous operation of the two columns is preferred.

This drying step is essential, both to meet food-grade specifications and to avoid frosting phenomena at the level of subsequent exchangers.

Step h)—Filtration(s)

The dried gas then undergoes one or more additional filtration steps to eliminate possible impurity traces. Filtration can be done on molecular sieves.

The gas then passes through a buffer tank, which functions to stabilize the pressure within the method and homogenize the gas composition. This tank is positioned downstream of the compressor so that the pressure at the compressor outlet is constant.

### Optional Filtration Step(s)

The gas can still undergo one or more new filtration steps, including using activated carbon, to eliminate possible impurities. The aim of filtration is for the gas to be as pure as possible before the liquefaction step i).

### Optional Cooling Step(s)

The gas can then pass through one or more heat exchangers to cool it progressively. The more the gas is cooled before the liquefaction step i), the lower the energy cost of this liquefaction step will be.

Preferably, the method includes a cooling step using a glycol water exchanger.

### Optional Filtration Step(s)

The gas can still undergo one or more new filtration steps, including using activated carbon, to eliminate possible impurities.

Step i)—First Liquefaction of the Gas

The gas then passes through a liquefier allowing the change of state of carbon dioxide. It changes from the gaseous state to the liquid state. The liquefier is an exchanger that uses a refrigerant fluid. At the liquefier outlet, a diphasic fluid, which includes liquefied carbon dioxide, is obtained. It is at a temperature between −25° C. and −35° C.

Step j)—Distillation

The fluid undergoes a distillation step to isolate the carbon dioxide in liquefied form. Thus, the liquefied carbon dioxide is recovered at the bottom of the column, while the gas is recovered at the top of the column. The temperature within the column is between −18° C. and −45° C. at a pressure between 15 and 25 bars.

### Optional Purge

At this stage of the method, the recovered carbon dioxide can be analyzed. Depending on the purity of the liquid obtained, the circuit can include a bypass valve. If the purity of the recovered liquid is not sufficient, the liquid can be sent to the atmosphere once reheated. If the purity of the recovered liquid is satisfactory, the liquid can be sent directly to a storage tank or used.

Step k)—Recovery of Liquefied Carbon Dioxide

The liquefied carbon dioxide is recovered. It can be sent to a tank for storage. It can also be used directly for a subsequent application.

Step l)—Second Liquefaction of the Gas

The gas recovered at the top of the distillation column in step j) is a gas including a carbon dioxide content lower than that of the gas entering the method according to the invention. This gas includes carbon dioxide, which has not liquefied during the method. This gas may possibly include oxygen, nitrogen, methane, hydrogen, and carbon monoxide depending on the initial gas source.

The gas then passes through a liquefier to be cooled to a temperature between −35° C. and −45° C.

This step allows the carbon dioxide, not yet liquefied and isolated at this stage of the method, to be liquefied. This step constitutes the second liquefaction step. At the end of this step, a diphasic fluid is obtained.

Step m)—Phase Separation

The diphasic fluid resulting from the previous step is brought to a separator, which allows the liquid phase to be separated from the gas phase.

Step n)—Recycling of the Liquid Phase to Distillation

The liquid phase resulting from the previous step, including the liquefied carbon dioxide, is recycled at the level of distillation step j).

Step o)—Optional Recycling of the Gas Phase

The gas phase resulting from the separation step m) can be reheated using an exchanger.

The reheated gas can be filtered on a membrane to separate a gas rich in carbon dioxide from a gas poor in carbon dioxide.

“Gas rich in carbon dioxide” means a gas composed of more than 50% by volume relative to the total volume of carbon dioxide gas.

“Gas poor in carbon dioxide” means a gas composed of less than 50% by volume relative to the total volume of carbon dioxide gas.

The gas rich in carbon dioxide can be recycled and sent into the circuit before the gas overpressure step c).

The gas poor in carbon dioxide can be recycled and sent to a unit for producing the gas treated by the method according to the invention.

For example, in the case of treating a purified biogas, if the gas includes mainly methane, it can be recycled to the methanization unit or the purification unit.

In the case of treating a gas from oxycombustion, if the gas includes mainly oxygen, it can be recycled to the combustion unit.

In the case of treating a gas from steam reforming, if the gas includes mainly hydrogen, it can be recycled to the steam reforming unit.

Therefore, depending on the gas treated, it is possible to recycle, thus valorize, the gases recovered following the liquefaction of carbon dioxide.

### Device

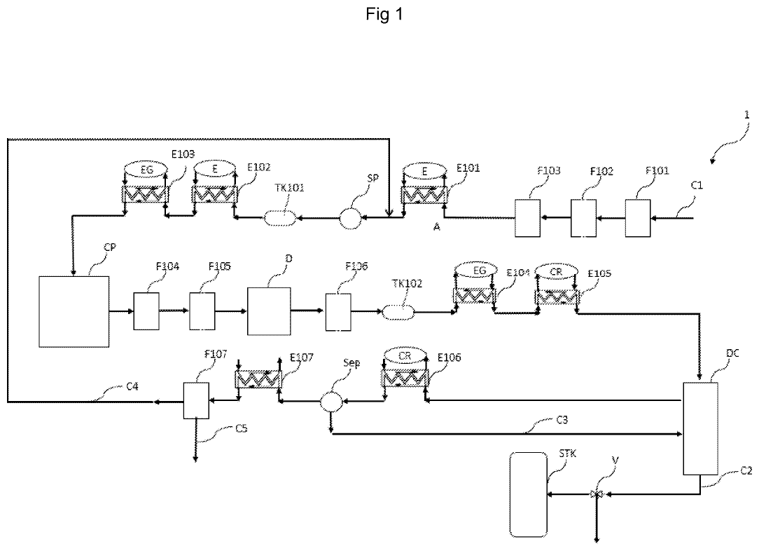

The invention also relates to the device, which allows the method according to the invention to be implemented. This device is illustrated in FIG. 1. This figure represents an embodiment according to the invention.

The device for producing liquid carbon dioxide, also called gas liquefaction installation, can be arranged, for example, at the outlet of a biogas purification unit, at the outlet of a unit for recovering gases produced by a cement plant, at the outlet of a steam reforming unit, or at the outlet of an oxycombustion unit. The device 1 is fluidically connected to a unit for producing a gas rich in carbon dioxide via the inlet C1.

Preferably, the device according to the invention is located on the site of methanization and biogas purification.

The gas to be treated is brought into the device according to the invention via an inlet pipe C1. The gas is brought into a filtration unit F101 to undergo a first purification. A succession of several filtrations can be carried out. FIG. 1 illustrates the succession of 3 filtration units F101, F102, and F103. Preferably, the filtration units F101 and F102 use activated carbon, and the filtration unit F103 is on a molecular sieve.

The gas is then brought to an exchanger E101 to undergo a first cooling. The exchanger E101 can use water as the cooling fluid. Air is denoted A in FIG. 1.

The gas thus cooled is then brought to a booster SP to impose on the gas at the booster outlet a pressure higher than atmospheric pressure.

At the booster SP outlet, the gas is brought into a buffer tank TK101 allowing the pressure of the gas to be regulated within the method.

The gas is then brought to one or more exchangers, preferably two exchangers E102 and E103, to cool the gas before its entry into the compressor CP. The exchanger E102 can use water as the cooling fluid. Water is denoted E in FIG. 1. The exchanger E103 can use glycol water as the cooling fluid. Glycol water is denoted EG in FIG. 1.

The gas is then brought into the oil-free dry compressor CP. At the compressor outlet, the gas is preferably at 206° C. and 25 bars.

Then, this gas is brought into two successive filtration units F104 and F105 to eliminate impurities and water traces.

This gas is then brought into a drying device D to eliminate all water traces.

At the drying device D outlet, the gas is filtered again to eliminate residual impurity traces using the filtration unit F106. The gas is then conducted into a buffer tank TK102. This buffer tank allows the pressure of the gas to be stabilized within the device and the gas composition to be homogenized.

The gas is then brought into the exchanger E104 to cool it, then into the liquefier E105, to liquefy the carbon dioxide present in the gas.

According to a preferred embodiment, the device may include at least one filtration unit between the heat exchanger E104 and the liquefier E105, advantageously two filtration units.

At the liquefier E105 outlet, the carbon dioxide within the fluid is in liquid form. The fluid at the liquefier E105 outlet is at a temperature between −25° C. and −35° C.

At this stage of the method, the gas is partially or even totally liquefied. Between the exchanger E104 and the liquefier E105, the device may include filtration units to eliminate remaining impurities, notably if food-grade carbon dioxide is targeted.

The gas is then conducted into the distillation column DC.

The liquefied carbon dioxide is recovered at the bottom of the distillation column DC.

If the gas is of satisfactory purity, then it can be conducted into a storage tank STK.

If the gas is not of satisfactory purity, then it can be sent into the atmosphere using the valve V.

The gas mixture recovered at the top of the distillation column DC is conducted into the liquefier E106.

At the liquefier E106 outlet, the fluid is diphasic. It is brought to the separator Sep.

The liquid phase, resulting from the separator Sep, which includes liquefied carbon dioxide, is sent back to the distillation column DC via the pipe C3.

The gas phase, resulting from the separator Sep, is reheated using the exchanger E107, then brought to a membrane filtration unit F107.

The filtration unit F107 separates a gas rich in carbon dioxide that has not been liquefied during the method from a gas poor in carbon dioxide. The gas rich in carbon dioxide is recycled upstream of the booster SP via the pipe C4. The gas poor in carbon dioxide is possibly recycled via the pipe C5 to the unit for producing the gas treated by the method according to the invention.

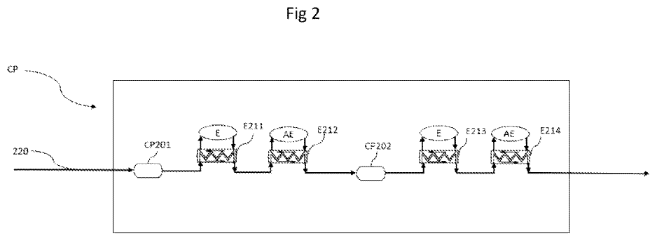

FIG. 2 illustrates an embodiment of the oil-free dry compressor CP. This is a two-stage compressor. The compression stages of the circuit are mounted in series. This means that the compressors are located on the same branch of the circuit. The increase in the pressure of the gas allows the power necessary for the liquefaction of the mixture to be reduced and improves the yield of the method. To avoid the increase in the temperature of the gas at the compressor outlet, compression is carried out in two steps. This improves the yield of the compression by cooling the gas at the outlet of each stage. The compressor is also protected from possible overheating.

The gas from the exchanger E103 illustrated in FIG. 1 enters the compressor CP via the pipe 220. The gas is brought to the compressor CP201. At the compressor CP201 outlet, the thermal energy generated by the compression is recovered by the exchanger E211, then the exchanger E212. These exchangers allow the gas to be cooled and the fluid inside the exchanger to be heated.

At the exchanger E212 outlet, the gas is brought to the compressor CP202. At the compressor CP202 outlet, the thermal energy generated by the compression is recovered by the exchanger E213, then the exchanger E214.

According to a particular embodiment, the exchangers E211 and E213 use water as the heat transfer fluid. This water heated by the exchangers can be used to heat structures located near the device according to the invention. The exchangers E212 and E214 use air as the heat transfer fluid. The exchangers E211 and E212 and independently the exchangers E213 and E214 allow a decrease in the temperature of the gas.

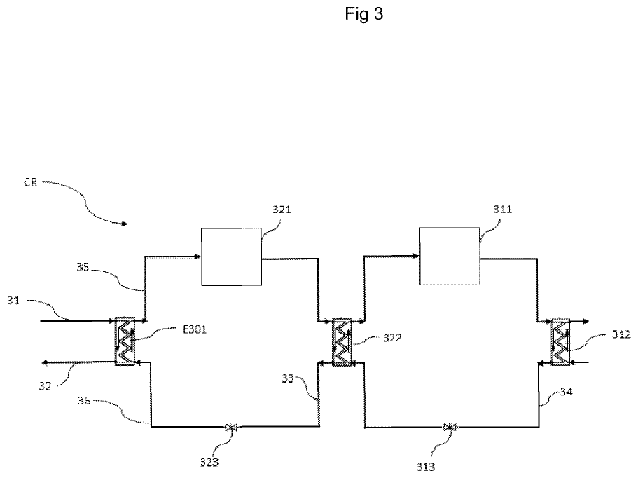

FIG. 3 illustrates an embodiment of a cooling device. The device for producing liquid carbon dioxide according to the invention includes two liquefiers E105 and E106 illustrated in FIG. 1. FIG. 3 illustrates a cooling device CR that can be connected to the liquefiers E105 and E106. This cooling device is connected to a liquefier E301; at its inlet a non-liquefied gas 31 is introduced, and at its outlet, a liquefied gas 32 is extracted. On the other hand, the liquefier E301 includes an outlet 35 and an inlet 36. The outlet 35 and inlet 36 are intended to be fluidically connected to the cooling device CR.

According to this embodiment, the cooling device CR includes a series of two independent cooling circuits positioned in cascade comprising here a low-temperature cooling circuit 33 and a high-temperature cooling circuit 34. The basic principle of the cooling device is that the low-temperature cooling circuit 33 extracts calories from the liquefier E301 by being fluidically connected to the outlet 35 and inlet 36 of the liquefier E301. On its side, the high-temperature cooling circuit 34 extracts calories from the low-temperature cooling circuit 33. Thus, the two high-temperature 34 and low-temperature 33 cooling circuits are independent and are parallel to each other, while being in cascade.

In a manner known per se, the high-temperature cooling circuit 34 includes in the direction of circulation of a first refrigerant fluid illustrated by the arrows in the figure, an associated compressor 311, a condenser 312, here in the form of a heat exchanger, which allows calories from the high-temperature cooling circuit 34 to be extracted to the outside of the cooling device. Downstream of the condenser 312, the high-temperature cooling circuit 34 includes an expander 313.

On its side, the low-temperature cooling circuit 33 includes, still in the direction of circulation of a second refrigerant fluid, which is associated with it, illustrated by the arrows in the figure, an associated compressor 321 followed by a condenser 322 followed by an expander 323. The condenser 322 is here a heat exchanger whose second part forms an evaporator for the high-temperature cooling circuit 34 wherein it is integrated downstream of the expander 313 and upstream of the compressor 311 of the high-temperature cooling circuit 34. Thus, the condenser/evaporator 322 forms, here in this embodiment of the cooling device CR, means of calorie extraction thermally connecting the low-temperature cooling circuit 33 to the high-temperature cooling circuit 34.

The low-temperature cooling circuit 33 includes downstream of the expander 323 an outlet pipe fluidically connected to the inlet 36 of the liquefier E301. Similarly, the low-temperature cooling circuit 33 comprises an inlet pipe upstream of the compressor 321, which is fluidically connected to the outlet 35 of the liquefier E301.

The low-temperature cooling circuit 33 and the high-temperature cooling circuit 34 may include downstream of the compressors separators to separate the oil extracted from the compressor. A recycling loop of this oil to the compressor is conceivable.

According to a preferred embodiment of the installation according to the invention, the liquefaction device 1 according to the invention is comprised in a container. A container is a box of standardized dimensions that can be used for handling, storage, or transport of materials or batches of objects, allowing the packaging of said objects to be simplified. For example, the container in which the liquefaction device is arranged can be a maritime transport container as standardized in ISO 668:2020 and ISO 1496-3 standards. Thus, the liquefaction device is easily transportable and can be installed near the unit for producing the gas to be liquefied.

The examples that follow allow the present invention to be illustrated but are in no way limiting.

### Examples

### 1. Purity of the Liquid Carbon Dioxide Produced

A gas from a biogas purification unit produced by a methanizer with the following composition is treated by the method according to the invention:

TABLE 1

| | |
|---|---|
| CO₂ | 91.7% |
| CH₄ | 8% |
| O₂ | 0.15% |
| N₂ | 0.15% |

At the method outlet, the gas is of the following composition:

TABLE 2

| | Unit | Specification | Analysis |
|---|---|---|---|
| CO₂ | % | >=99.90 | >100 |
| H₂O | ppm | <=20.00 | <1 |
| CO | ppm | <=5.00 | =1.05 |
| NOx | ppm | <=2.00 | =0.01 |
| S | ppm | <=0.10 | =0.01 |
| CH₃OH | ppm | <=10.00 | =0.00 |
| CH₃CHO | ppm | <=0.20 | =0.01 |
| THCoCH₄ | ppm | <=20.00 | =0.00 |
| C₆H₆ | ppm | <=0.02 | =0.00 |
| H₂ | ppm | <=10.00 | =0.02 |
| NH₃ | ppm | <=2.50 | =0.00 |
| N₂ | ppm | <=60.00 | =0.02 |
| O₂ | ppm | <=30.00 | =0.00 |

The carbon dioxide produced complies with the European Pharmacopoeia, the EN936/EIGA/ISBT standard, and the RE 231/2012CE regulation.

### 2. Energy Consumption of the Method

The method according to the invention consumes from 0.18 kW/h to 0.27 kW/h per kg of liquid CO₂ produced, depending on the composition of the gas treated.

1. A method for producing liquid carbon dioxide from a gas containing more than 70% by volume of carbon dioxide comprising the following successive steps:
a) one or more filtration steps using activated carbon, then
b) one or more gas cooling steps, the temperature of the gas at the end of this step being between 1° and 20° C., then
c) a gas overpressure step, the gas pressure at the end of this step being between 1.05 and 1.40 bar,
d) one or more gas cooling steps, then
e) a gas compression step, the gas pressure at the end of this step being between 15 and 25 bars, then
f) one or more filtrations, then
g) a gas drying step, then
h) one or more filtrations, then
i) a gas liquefaction step, the fluid at the end of this step being at a temperature between −25° C. and −35° C., then
j) a step of distilling the fluid so as to isolate the liquefied carbon dioxide,
k) a step of recovering carbon dioxide in liquid form from step j),
l) a step of liquefaction of the gas recovered at the top of the distillation column in step j), the gas at the end of this step being at a temperature between −35° C. and −45° C., then
m) a step of separating the liquid phase from the gas phase of the fluid resulting from the liquefaction step 1), then
n) a step of recycling the liquid phase resulting from the separation of step m) to the distillation step j).

2. The method according to claim 1, characterized in that it includes a particle filtration step between steps a) and b).

3. The method according to claim 1, characterized in that it includes a gas cooling step between steps h) and i).

4. The method according to claim 1, characterized in that it includes the following successive steps:
a step of heating the gas phase obtained from step m),
a step of membrane filtration of the heated gas phase,
a step of recycling the gas obtained from the previous filtration step and composed of more than 50% by volume relative to the total volume of carbon dioxide gas, before the overpressure step c).

5. The method according to claim 1, characterized in that the gas including more than 70% by volume of carbon dioxide is a gas originating from a methanization unit, a gas originating from a biogas purification unit, a gas originating from a steam reforming unit, a gas originating from an oxycombustion unit, or a gas originating from a unit for recovering gases produced by a cement plant.

6. A device for producing liquid carbon dioxide (1) from a gas including more than 70% by volume of carbon dioxide, characterized in that it includes the following elements, fluidically connected to one another and in this order:
at least two filtration units (F101, F102, F103) mounted in series,
a heat exchanger (E101) to cool the gas,
a booster (SP),
a buffer tank (TK101),
at least two exchangers (E102, E103) mounted in series,
an oil-free dry compressor (CP),
at least one filtration unit (F104, F105),
a drying device (D), so as to eliminate traces of humidity,
at least one filtration unit (F106),
a buffer tank (TK102),
at least one heat exchanger (E104),
a liquefier (E105),
a distillation column (DC),
the foot of the distillation column (DC) being fluidically connected to a pipe (C2) allowing the recovery of liquefied carbon dioxide,
the head of the distillation column (DC) being connected to a liquefier (E106) so as to liquefy the carbon dioxide remaining in the gas, then connected to a separator (Sep),
a pipe (C3) connects the separator (Sep) to the distillation column (DC), allowing the recycling of the liquid phase mainly including carbon dioxide.

7. The device according to claim 6, characterized in that the compressor (CP) is a multi-stage compressor, equipped with at least two compressors mounted in series (CP201, CP202), and equipped with at least two heat exchangers (E211, E212 and E213, E214) mounted in series and positioned downstream of each compressor.

8. The device according to claim 6, characterized in that the liquefiers (E105, E106) are connected to cooling devices, including at least two cooling circuits mounted in cascade (33, 34).

9. The device according to claim 6, characterized in that the separator (Sep) is fluidically connected to a heat exchanger (E107), then to a membrane filtration unit (F107),
a pipe (C4) connects the filtration unit (F107) to the pipe upstream of the booster (SP) so as to recycle the gas including carbon dioxide.

10. The device according to claim 6, characterized in that the pipe (C2) arranged at the outlet of the distillation column (DC) is connected to a valve (V), then to a storage tank (STK), recovering the liquefied carbon dioxide.

11. The device according to claim 6, characterized in that it includes at least one filtration unit between the heat exchanger (E104) and the liquefier (E105).

12. The device according to claim 6, characterized in that it includes at least one filtration unit between the buffer tank (TK102) and the heat exchanger (E104).

13. The device according to claim 6, characterized in that it is arranged inside a container, preferably a maritime transport container.

14. A use of the device as defined in claim 6 for liquefying a gas originating from a methanization unit, a biogas purification unit, a steam reforming unit, an oxycombustion unit, or a unit for recovering gases produced by a cement plant.
